(19) United States
(12) Patent Application Publication
(10) Pub. No.: US 2026/0233178 A1
(43) Pub. Date: Aug. 13, 2026

(54) SYSTEMS AND METHODS FOR AUTOMATED BLENDING

(71) Applicant: 6D Bytes Inc., Sunnyvale, CA (US)

(72) Inventors: Kevin Andrew Marshall, Sunnyvale, CA (US); Venkateswaran Ayalur, Cupertino, CA (US)

(21) Appl. No.: 19/531,375

(22) Filed: Feb. 5, 2026

Related U.S. Application Data
(60) Provisional application No. 63/757,472, filed on Feb. 12, 2025.
(60) Provisional application No. 63/893,326, filed on Oct. 3, 2025.

(51) Int. Cl. B01F 27/807; B01F 27/90; B01F 35/11; B01F 35/21; B01F 35/22; B01F 35/30; B01F 101/14

(52) U.S. Cl. CPC B01F 27/807; B01F 27/90; B01F 35/11; B01F 35/2117; B01F 35/2209; B01F 2035/351; B01F 2101/14

(57) ABSTRACT

Embodiments of the present disclosure include systems and methods for automated blending. In one embodiment, the present disclosure includes a cup holder, cup arm, blender blade arm, and blender blades. The blender blade arm rotates the blender blades around an axis and attaches to the cup arm. The cup arm and blender blade arm rotate to invert a cup in the cup holder and couple the blender blades to a blender. Ingredients in the cup may be blended while the cup is inverted. Embodiments may include a rinse cap to cover the blender blades during cleaning.

### CROSS REFERENCE TO RELATED APPLICATIONS

This application claims priority to U.S. Provisional Patent Application No. 63/757,472, filed Feb. 12, 2025, the contents of which are hereby incorporated herein by reference.

This application claims priority to U.S. Provisional Patent Application No. 63/893,326, filed Oct. 3, 2025, the contents of which are hereby incorporated herein by reference.

### BACKGROUND

The present disclosure relates to apparatuses, systems, devices, and methods for automated blending.

Blenders are typically utilized to blend ingredients placed in a receptable of a blender. When blending food ingredients, for example, a user typically places desired ingredients in the blender receptable, places a lid on the receptacle, and then actives a motor that turns a mixing blade in the receptacle to thereby blend the ingredients. The user typically holds the lid in place on the blender during this process to prevent ingredients from being ejected from the receptacle during blending. Where the process of blending is to be automated, a number of challenges arise. One challenge pertains to securely placing a lid on the receptacle used for blending. If the lid is not securely placed on the blender receptacle, leakage from the receptacle can occur that necessitates cleaning of the blender system, which may be more difficult in an automated system. Another challenge pertains to obtaining a uniform blend of the ingredients. Another challenge is cleaning of the blender receptacle, particularly when blending different food items. In this situation, the blender receptacle may need to be cleaned between each recipe. Accordingly, it may be desirable to minimize drips from either the food being blended or the water used for cleaning.

The present disclosure introduces automated blender techniques that address some or all of the challenges above.

### BRIEF DESCRIPTION OF THE DRAWINGS

FIG. 1 illustrates an automated blender according to an embodiment.

FIG. 2 illustrates automated blender method according to an embodiment.

FIG. 3 illustrates one example automated blender according to an embodiment.

FIG. 4 illustrates a view of an example automated blender in one position according to an embodiment.

FIG. 5 illustrates a view of an example automated blender in another position according to an embodiment.

FIG. 6 illustrates a view of an example automated blender in yet another position according to an embodiment.

FIG. 7 illustrates a view of an example automated blender in an inverted position according to an embodiment.

FIG. 8 illustrates a view of an example automated blender in another position according to an embodiment.

FIG. 9 illustrates a view of an example automated blender in a blend completed position according to an embodiment.

FIG. 10 illustrates a view of an example automated blender with a rinse cap in one position according to an embodiment.

FIG. 11 illustrates a view of an example automated blender with the rinse cap in another position according to an embodiment.

FIG. 12 illustrates a view of an example automated blender with the rinse cap in yet another position according to an embodiment.

FIG. 13 illustrates a view of an example automated blender with magnetic coupling according to an embodiment.

FIG. 14 illustrates a view of an example automated blender rinse cap according to an embodiment.

FIG. 15 illustrates a view of an example automated blender cup holder according to an embodiment.

FIG. 16 illustrates a view of an example automated blender clip mechanism in one position according to an embodiment.

FIG. 17 illustrates a view of an example automated blender clip mechanism in another position according to an embodiment.

FIG. 18 illustrates a view of an example automated blender clip and clip arm in a first position according to an embodiment.

FIG. 19 illustrates a view of an example automated blender clip and clip arm in a second position according to an embodiment.

FIG. 20 illustrates a view of an example automated blender ball according to an embodiment.

FIG. 21 illustrates a view of an example automated blender alignment system according to an embodiment.

FIG. 22 illustrates a view of an example rinse arm and cylinder in a first position according to an embodiment.

FIG. 23 illustrates a view of an example rinse arm and cylinder in a second position according to an embodiment.

FIG. 24 illustrates a view of example rinse and cup rails in one position according to an embodiment.

FIG. 25 illustrates a view of example rinse and cup rails in another position according to an embodiment.

FIG. 26 illustrates a view of example rails and pivot lever according to an embodiment.

FIG. 27 illustrates another view of example rails and pivot lever according to an embodiment.

FIG. 28 illustrates yet another view of example rails and pivot lever according to an embodiment.

FIG. 29 illustrates a flow chart of a blend cycle and rinse cycle according to an embodiment.

FIG. 30 illustrates another example automated blender system according to an embodiment.

FIG. 31 illustrates a view of an example automated blender in a first position according to an embodiment.

FIG. 32 illustrates a view of an example automated blender in a second position according to an embodiment.

FIG. 33 illustrates a view of an example automated blender in a third position according to an embodiment.

FIG. 34 illustrates a view of an example automated blender in a fourth position according to an embodiment.

FIG. 35 illustrates a view of an example automated blender in a fifth position according to an embodiment.

FIG. 36 illustrates a view of an example automated blender in a sixth position according to an embodiment.

FIG. 37 illustrates a view of an example automated blender and rinse cap in one position according to an embodiment.

FIG. 38 illustrates a view of an example automated blender and rinse cap in another position according to an embodiment.

FIG. 39 illustrates a view of an example automated blender with removeable blender blades according to an embodiment.

FIG. 40 illustrates a view of an example automated blender with removeable parts according to an embodiment.

### DETAILED DESCRIPTION

Described herein are techniques for automated blending. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure may be used to automatically blend ingredients in a cup, which may avoid transferring ingredients to a blending receptacle and then to a cup for delivery to a consumer, thus providing a range of advantages over typical automated blender systems.

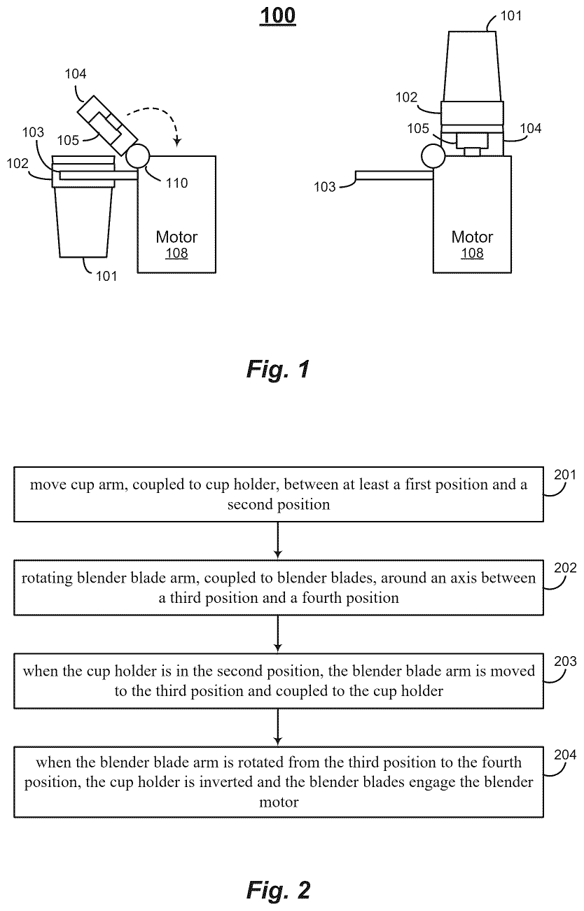

FIG. 1 illustrates an automated blender apparatus 100 according to an embodiment. Automated blender 100 includes a cup holder 102 configured to receive a cup 101, a cup arm 103, a blender blade arm 104, blender blades 105, and a blender motor 108. The cup 101 may include ingredients to be blended, for example, which may be automatically dispensed directly into the cup rather than to a blender receptacle. In some embodiments, cup 101 may be placed in cup holder 102, for example, by a robotic system, such as a robotic arm (not shown). Cup holder 103 is coupled to cup arm 103, and cup arm 103 may be movable to move the cup holder between at least two positions. For example, in some example embodiments, cup arm 103 moves vertically or rotationally, or both, as illustrated in various examples below. By way of example, in one position, cup arm 103 may position cup holder 102 to receive cup 101. In a second position, cup arm 103 may move cup holder 102 (and cup 101) to another position to engage blender blade arm 104 as illustrated below.

Blender blade arm 104 is coupled to the blender blades 105. As illustrated in FIG. 1, blender blade arm 104 rotates around an axis between different positions. Cup holder 102 may be moved to a position and blender blade arm 104 may be moved to a position such that blender blade arm 104 is coupled to cup holder 102. Blender blade arm 104 may be configured to form a seal around cup 101, for example, when blender blade arm 104 is coupled to cup holder 102. The seal may be a liquid tight seal to prevent leakage during blending as described further below. Next, blender blade arm 104 is rotated to another position, and cup holder 102 is inverted. In the inverted position, blender blades 105 engage a blender motor 108. Accordingly, blender motor 108 may be activated and blending of ingredients may be performed inside cup 101.

After blending, blender blade arm 104 is rotated back to the initial position such that cup 101 is no longer inverted. Cup arm 103 is coupled to cup holder 102, and blender blade arm 104 is decoupled from cup holder 102. Cup arm 103 may be moved to another position to facilitate further movement of the cup 101 (e.g., by a robotic arm). In various embodiments, a rinse cap (not shown) may be positioned to couple to blender blade arm 104. The rinse cap and blender blade arm 104 may similarly form a liquid tight seal. The rinse cap and blender blade arm 104 may similarly be rotated so that blender blades 105 engage blender motor 108. Rinse cap may include a liquid input to facilitate water or another cleaning solution to be injected into a space created between the rinse cap and blender blade arm 104. For example, water may be injected into the space and blender motor 108 activated to clean blender blades 105 between uses.

FIG. 2 illustrates automated blender method according to an embodiment. At 201, a cup arm, coupled to a cup holder, is moved between at least a first position and a second position. At 202, a blender blade arm, coupled to blender blades, is rotated around an axis between a third position and a fourth position. At 203, when the cup holder is in the second position, the blender blade arm is moved to the third position and coupled to the cup holder. At 204, when the blender blade arm is rotated from the third position to the fourth position, the cup holder (and a cup) is inverted and the blender blades engage the blender motor.

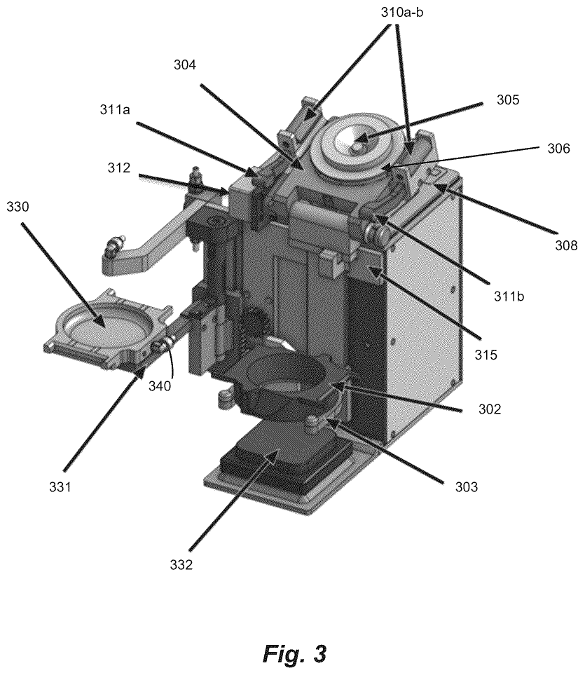

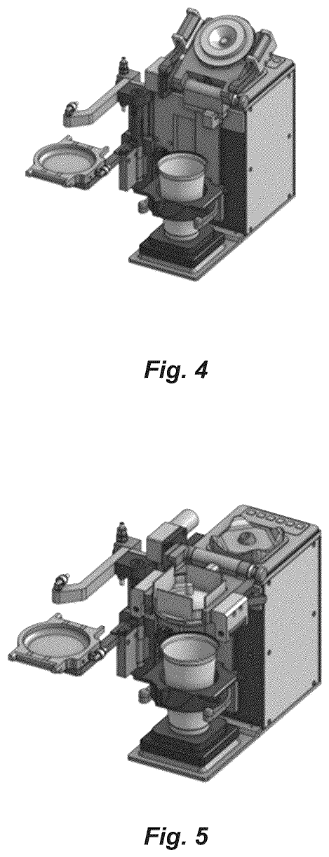

FIG. 3 illustrates one example automated blender according to an embodiment. This example design may be used to blend a drink inside of a standard cup. The flow may comprise a cup containing frozen solids, liquids, and/or powders, for example, is placed in the device, and without any external help the contents of the cup are blended into a drink. Once blended, a robot or human may pick up the cup from the mechanism. This example mechanism has several components that interact to blend the contents of a disposable cup, which may then clean the blades that interact with food inside the cup. The basic operation of this mechanism is shown in FIGS. 4-12. As shown in FIG. 3, automated blender comprises a cup holder 302, cup arm 303, blender blade arm 304, blender blades 305, and a blender motor 308 as described above. In this example, blender blade arm 304 includes a circular surface 306 to form a seal with a cup. Circular surface 306 extends from a surface of the blender blade arm 304 to facilitate engagement with a cup, for example. In this example, blender blade arm 304 is coupled to cup holder 302 using blade arm clips 310a-b and clip plungers (aka, clip arms) 311a-b on both sides of the cup holder, which are deflected by housing plate 315 as described in more detail below. As used herein, a clip and a clasp are used interchangeably to mean a device, which may be flexible or worked by a spring, for holding an object or objects together or in place. In this example, blender blade arm 304 is rotated by motor 312. The automated blender further includes rinse cap 330, rinse arm 331, fluid input nozzle 340, and cup measurement scale 332.

FIG. 4 shows the example mechanism at rest, with a cup placed in the cup holder. In this position, the cup is resting with its weight on the scale, and the cup holder may center it on the scale. This way, the weight of the drink may be accurately measured by the measurement scale, which may further determine that the cup is correctly placed in the mechanism.

FIG. 5 shows the blade arm rotated forward in position so that it can grab the cup. The blade arm clips are forced open as the clip plungers hit the front plate 315 of the blender housing.

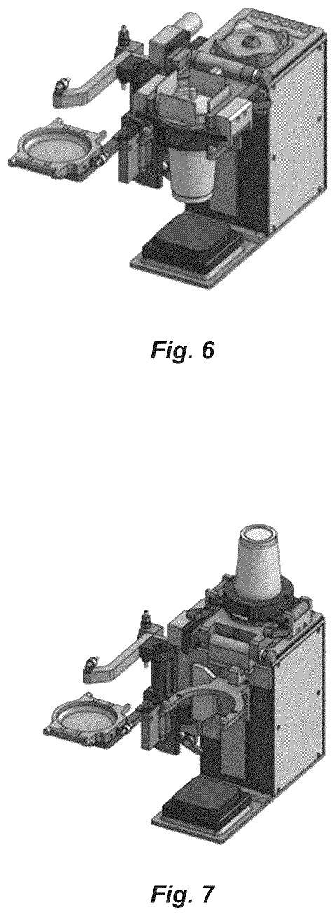

FIG. 6 shows the mechanism as the cup arm is lifted into place. The cup holder slides onto alignment features of the blade arm clip frame. These alignment features are shown in more detail in FIG. 21. The blender blade arm circular surface forms a leak proof seal with the cup in this position.

FIG. 7 shows the blade arm rotated back by a rotational motor to the blender motor. Since the cup and cup holder were engaged with the blade arm clips on the blender blade arm, the clips grab the cup holder when the blade arm rotates to the blender motor. The blender motor can now run and blend the contents of the cup.

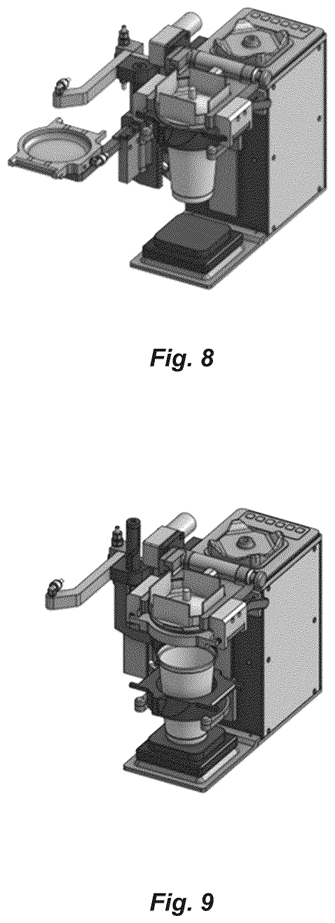

FIG. 8 shows the cup, cup holder, and the blade arm rotated back to the front of the mechanism so that the cup can be released. Since the blade arm is rotated to the front, the blade arm clips are forced open when the distal ends of the plungers engage the front plate of the blender housing as mentioned above and described further below.

FIG. 9 shows the cup arm being lowered fully, and the rinse cap being rotated and lifted into place under the blender blade arm. The cup holder is released because the blade arm clips are forced open. The cup arm lowers fully, and then an arm switchover mechanism rotates the rinse arm and rinse cap horizontally under the blade arm and lifts the rinse cap arm up to the blades to engage the blade arm clips. The rinse arm rotates the rinse cap to the blades with the rinse arm rotating lifter configured on the linear rail, for example.

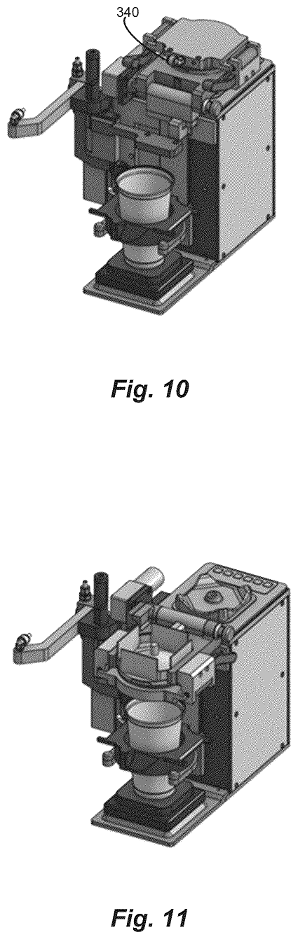

FIG. 10 shows the rinse cap being rotated vertically onto the blender by the blade arm. It is grabbed while lifting by the blade clips in the same fashion as the cup holder was lifted from the cup arm. Once the rinse cap is in place on the blender, water is pumped into the cap through fluid input nozzle 340, and the blender can run. This rinses residue (e.g., of a smoothie) off of the blades, and then the water can be pumped out of fluid input nozzle 340, for example.

FIG. 11 shows the rinse cap rotated vertically back to the rinse arm, ready to be disengaged.

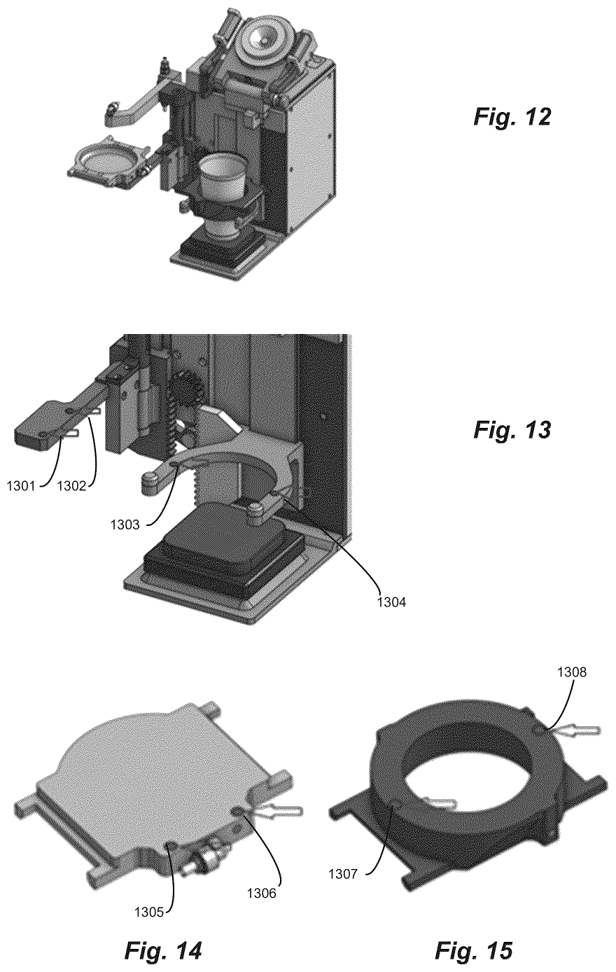

FIG. 12 shows the rinse arm lowered and rotated horizontally back to a home state, and the blade arm returned to a home as well.

The present example illustrates a number of features that allow this blending setup to function as in the example above. FIG. 13 illustrates an example cup arm and rinse arm according to an embodiment. FIG. 14 illustrates an example rinse cap according to an embodiment. FIG. 15 illustrates an example cup holder according to an embodiment. In these examples, the cup arm, cup holder, rinse arm, and rinse cap comprises magnets 1301-1308. Magnetic attachment of the cup holder and the rinse cap allow the system to switch between using and storing these parts. Magnets 1305 and 1306 couple to magnets 1301 and 1302 to couple the rinse cap to the rinse arm, and magnets 1307 and 1308 couple to magnets 1303 and 1304 to couple the cup holder to the cup arm. To lift the cup holder or rinse cap off of their magnetic holders, the clip mechanism mentioned above automatically grabs an attachment (the cup holder or the rinse cap) when the blade arm is rotated while an attachment is present. Finally, to keep these mechanisms compact, the present example uses a rotating arm mechanism to compactly insert the rinse cap, and a linear rail handoff system is used to shorten the height each arm takes.

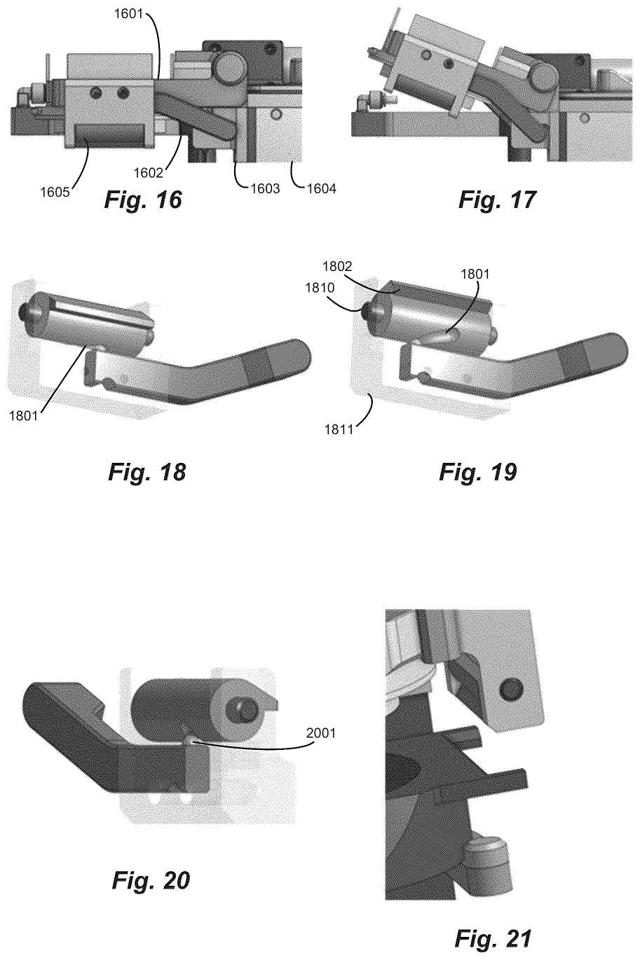

To securely lift the cup holder and/or rinse cap off of their magnetic mounts, this example uses an automatic clip mechanism (e.g., blade arm clips 310a-b). When the blade arm is rotated into position to receive an attachment, the clip plungers 311a-b are forced open. This is shown in FIGS. 16 and 17. When the blade arm 1601 is rotated back towards the blender motor, the plungers (e.g., clip arm 1602) are no longer depressed by contact with the housing plate 1603 on the blender frame 1604. Since there is a spring that forces the plungers back to their normal position, the plungers slide horizontally, which rotates the clips 1605 to grab any attachments that are in contact with clips. FIG. 16 illustrates the blade arm in a first position to receive an attachment, where the plunger engages the housing plate and forces the plunger forward to force the clips to open and receive the cup holder. In FIG. 17, the blade arm is rotated up, which allows the plungers to open as they are moved away from the housing plate. This causes the clips to rotate and start to grab the cup holder and cup. The clip rotation is shown in FIGS. 18 and 19. In one example embodiment, the linear plunger movement is converted to rotational movement by a curves groove 1801 in the clip body. In this example, the curve is a corkscrew shape. The clips may comprise round cylinders that rotate around an axel 1810 held in place by a clip frame 1811, for example, including flat extended portions 1802 to engage an edge of an attachment, such as the cup holder or rinse cap described above. A steel ball 2001, for example, may be held by the plunger, and as the ball rolls back and forth, it forces the clip to rotate based on the curvature of the groove. The plunger, ball, and clip groove are shown in FIGS. 18-20. FIG. 21 shows extrusions extending from the cup holder toward and on either side of the clip mechanism to align the cup holder and the clip frame. This example further includes a chamfered top that aligns the cup holder with the clip frame as the two pieces are brought into proximity. The same alignment extrusions and chamfered edges may be included on the rinse cap, for example.

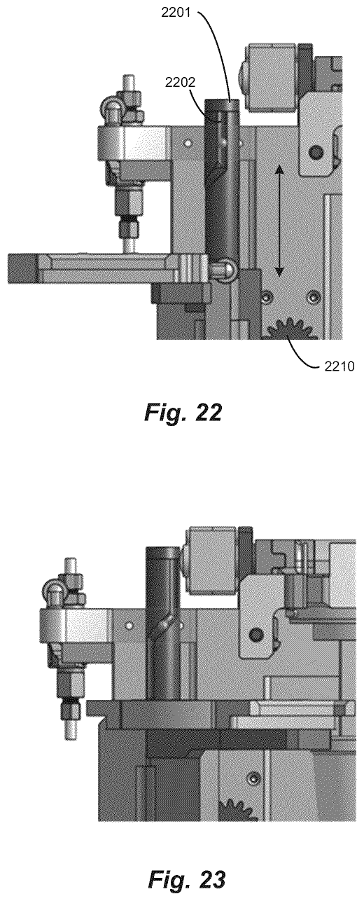

In one example embodiment, to compactly and quickly move the rinse cap onto the blade arm, the present example uses a linear rail coupled with a rotating rail mechanism. Referring to FIG. 3 and FIGS. 22-23, in this example, the same rotational rail driver 2210 engages both the rinse arm and the cup arm to move each arm between positions, where one position for each arm allows the respective attachment (e.g., cup holder and rinse cap) to couple to the blade arm. The movement of the rinse arm and rinse cap are illustrated further below. The rotation mechanism also keeps the cap horizontal and upward facing when off of the blades, which allows the system to catch excess rinse water and allows a cleaner rinsing operation. In this example, the rotation is done by attaching a rinsing cylinder 2201 to the rinsing arm and cutting a groove 2202 into the rinsing cylinder that corkscrews around the rinsing cylinder. The groove angle, curvature, and length (here, linear) may be configured to force the rinsing arm to rotate at the desired point and rate. Accordingly, as the rinse arm is moved vertically by the up and down motion of the rail driver, the arm rotates into position under the blender arm to attach to the blender arm. The rinse cap may then be coupled to the blender arm and inverted during cleaning similar to the above described approach with the cup. Steel balls may be used to align the groove and reduce friction and wear. This is similar to how the clip rotation mechanism works. The rail is shown moving straight up in FIG. 22 and moving through its rotation in FIG. 23.

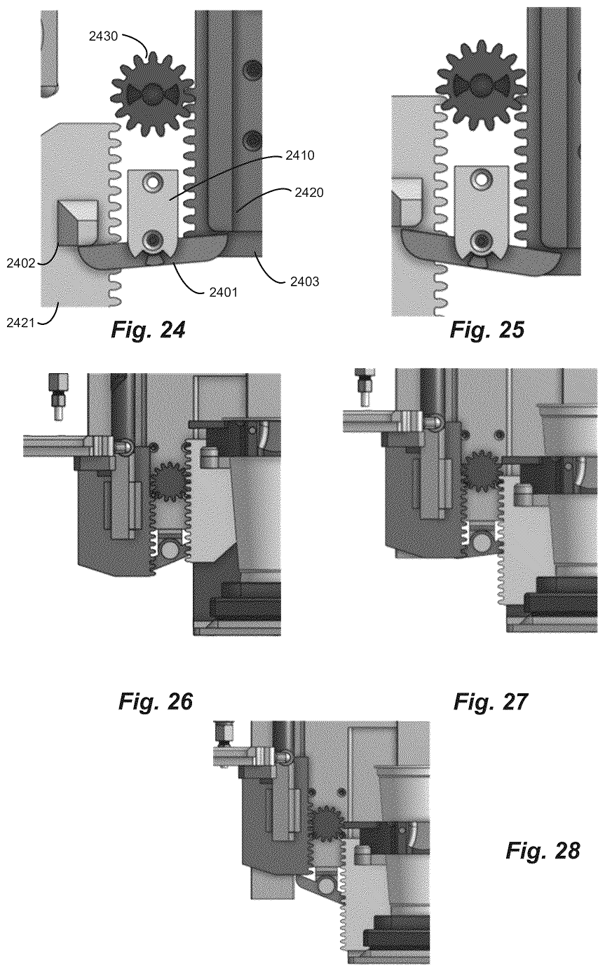

The following examples illustrate another aspect of the present disclosure. As mentioned above, to lift the cup holder or rinse cap, some embodiments may use a rack and pinion mechanism to move both the cup arm and rinsing arm along a linear rail. To reduce the amount of vertical space these rails take up, a switching mechanism may be used to switch between arms. Each arm is coupled to a rail (e.g., rinse arm rail 2402 and cup arm rail 2403). Each rail has a feature (e.g., extend elements 2420-2421 on the back) that hits (engages) a pivot lever 2401 on a pivot block 2410 configured between the arm rails. For example, FIG. 24 illustrates the rinse arm rail 2401 engaging the pivot lever 2401, which lifts the cup arm rail 2403. Alternatively, FIG. 25 illustrates the cup arm being lowered, which causes the pivot lever 2401 to raise rinse arm rail 2401. Accordingly, when one arm is lowered fully, it hits the pivot, which lifts the other arm onto the pinion gear 2430, which is coupled to a software controlled motor (not shown). When the other arm rises enough, the lowering arm drops off of the pinion gear and is no longer moved. This process is illustrated in FIGS. 26-28. This makes the mechanism about half the height that would otherwise be required. With a conventional rack and pinion setup, the lowering arm would have to drive down as the opposite arm is being raised. Since the lowering arm is disengaged from the gear in this example embodiment, there is no need to keep driving that arm down while the opposite arm is rising.

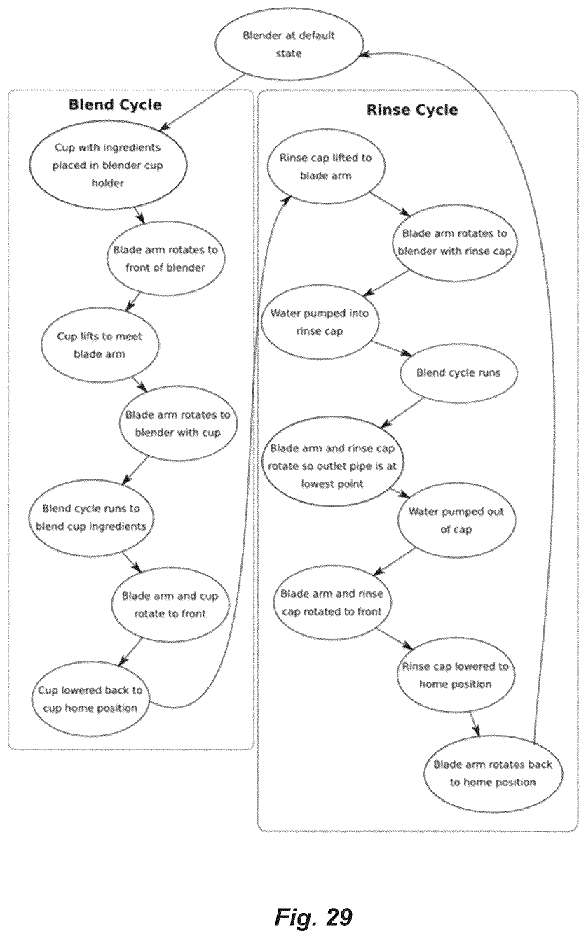

FIG. 29 illustrates one example algorithm for cup movement according to an embodiment. The algorithm illustrated in FIG. 29 may be software controlled (e.g., locally or remotely from the cloud). The algorithm in this example includes a blend cycle and rinse cycle. Once the blend cycle is completed, the rinse cycle is performed, after which the algorithm moves to a default state.

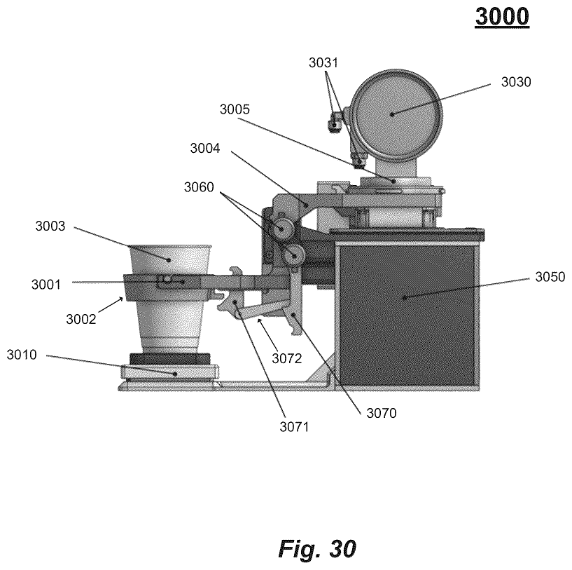

FIG. 30 illustrates another example blend in a cup mechanism 3000 according to embodiment. The example mechanism shown in FIG. 30 illustrates an alternative embodiment to the example mechanism shown in FIG. 3. However, it is to be understood that specific features of these two examples may be used in other embodiments in various combinations. Mechanism 3000 includes a cup arm 3001 coupled to a cup holder 3002 configured to receive a cup 3003 and a blade arm 3004 coupled to blender blades 3005. In this example, mechanism 3000 comprises scale 3010, a rinse cap 3030 coupled to rinse water ports 3031, and blender housing 3050. Blade arm 3004 and cup arm 3001 are coupled to arm holder pins 3060. Mechanism 3000 further includes lift pivot 3070, clasp (i.e., clip) mechanism 3071, and clasp arm 3072, which are described in more detail below.

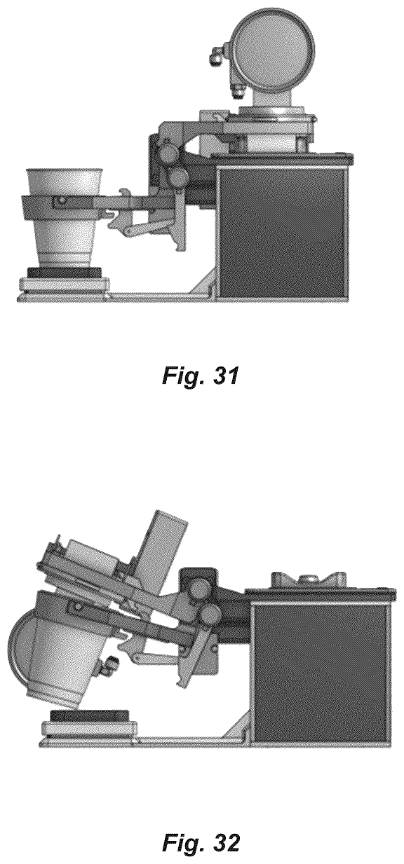

This design has several components that interact. The function and interaction of the components are shown in FIG. 31-36.

FIG. 31 shows the mechanism at rest, with a cup placed in the cup holder. In this position, the cup is resting with its weight on the scale. This way, we can accurately measure how heavy the drink is and that the drink is correctly placed in the mechanism.

FIG. 32 shows the mechanism as the cup arm is being lifted into place. Only the blade arm with the blender blades is powered, so the cup arm is raised via the lift pivot. As the blade arm moves toward the cup arm, the blade arm hits this lift pivot and pulls the cup arm up towards the blade arm. This may be used to lift the cup off the scale and bring the arms together.

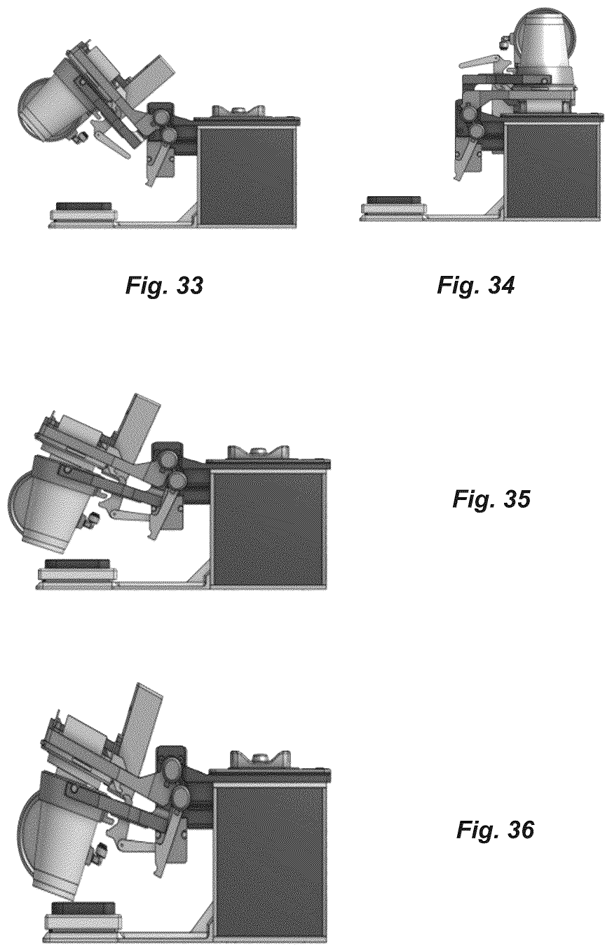

FIG. 33 shows the arms coupled together. In this example, the clasp on the cup arm will hold the two arms together when they are firmly pushed against each other to form a liquid tight seal. In this example, the blade arm may be driven into the cup arm, which engages a spring-loaded clasp and holds the arms together. Once in this state, the arms are locked together.

FIG. 34 shows both arms rotated so that the cup (now inverted) and blender blades are engaged with the blender motor. The blender motor can now run and blend the contents of the cup.

FIG. 35 shows the arms being driven back open. The clasp arm hits the lift pivot in this process which forces the clasp open, releasing the cup arm from the blade arm. This releases the drink and allows the cup arm to lower and the blade arm to return home.

FIG. 36 shows the cup released so that it can be grabbed, with the blade arm moved out of the way to sit on the blender.

In this example, the device is also equipped with a rinse cap. This feature can close a cap onto the blender blades after a drink has been blended and fill the cap and blades with water. This is done by two pumps with water lines running to the rinse cap. The first pump feeds fresh water into the cap. Once water is inside the rinse cap cavity, the blender blades are run, which forces any food particles off of the blades and all food contact surfaces. Once the blender blades have been cleaned, the dirty rinse water is pumped out of the rinse cap by the second pump. This clean cycle can be repeated as needed and once completed the blender blades are clean and ready to blend another drink.

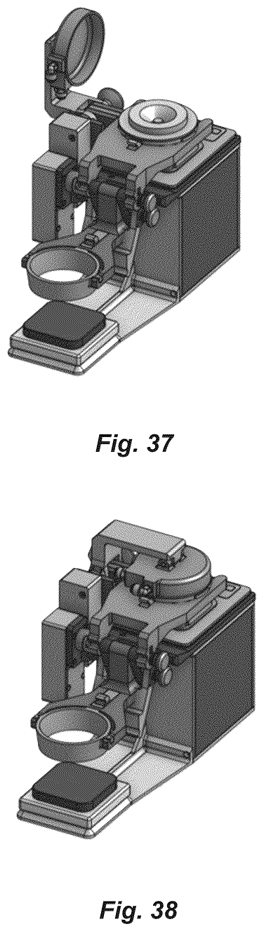

This functionality is shown in FIGS. 37 and 38. The rinse tubes are not shown in this rendering.

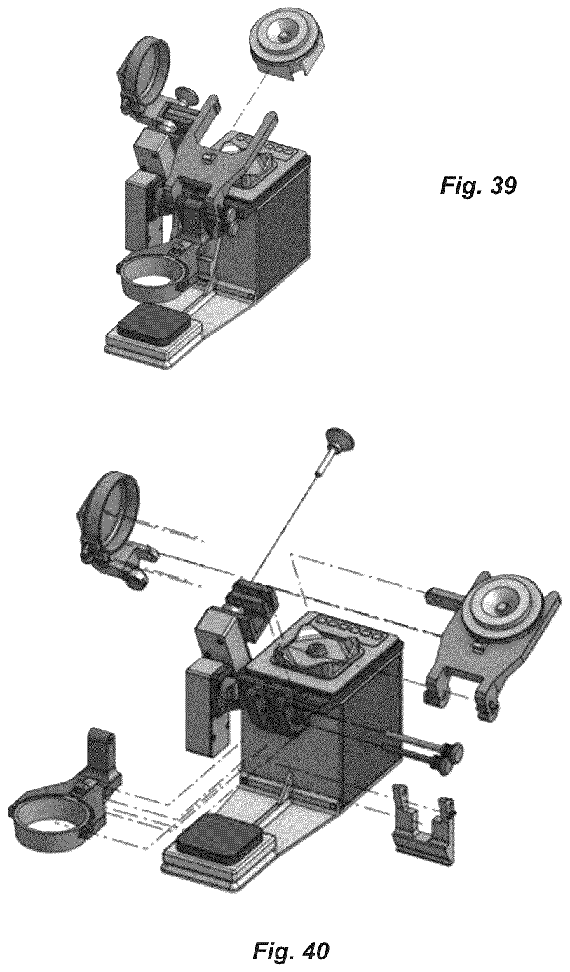

While the rinse cap can clean residue off the blender blades, in depth cleaning may be periodically needed in this example. During normal operation, the blender blades can be periodically removed for thorough cleaning. They are simply held in place by the elasticity of the blade arm, and pulling the blades away from the arm allows them to easily slide out. A clean set of blades can then be installed, and the dirty blades can be taken for cleaning. The removal blaes and process are shown in FIG. 39.

To clean spills or any residue build up on the rest of the machine, the pins holding the cup arm, blade arm, and rinse arm can be removed. This allows these parts to be taken off the mechanism and cleaned in a sink. The rest of the mechanism can then be wiped down with a cleaning solution. These pins and arm removal are shown in FIG. 40.

Embodiments of the present disclosure may include one or more sensors built in for monitoring smooth operation. The primary feedback is the scale that the cup is placed in. This lets the device verify a valid drink is given to the blender. The other sensors used may include hall effect sensors that let the device know the position of the arms in various states. Sensors may verify that the cup is picked up properly by the arm, that the blender blades reach the blender, and/or that the rinse cap closes on the blender blades, for example. This feedback helps the device detect any abnormal behavior and allows it to make corrective actions. This can include diagnosing improper assembly, wrong cups being used, or any device failures that might arise.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include apparatuses, systems, and methods.

In one embodiment, the present disclosure includes an apparatus comprising: a cup holder configured to receive a cup; a cup arm coupled to the cup holder to move the cup holder between at least a first position and a second position; blender blades; a blender blade arm coupled to the blender blades, wherein the blender blade arm rotates around an axis between a third position and a fourth position; a blender motor to engage the blender blades, wherein when the cup holder is in the second position, the blender blade arm is moved to the third position and coupled to the cup holder, and wherein when the blender blade arm is rotated from the third position to the fourth position, the cup holder is inverted and the blender blades engage the blender motor.

In another embodiment, the present disclosure includes a method comprising: moving a cup arm, coupled to a cup holder, between at least a first position and a second position; rotating a blender blade arm, coupled to blender blades, around an axis between a third position and a fourth position, wherein when the cup holder is in the second position, the blender blade arm is moved to the third position and coupled to the cup holder, and wherein when the blender blade arm is rotated from the third position to the fourth position, the cup holder is inverted and the blender blades engage the blender motor.

In one embodiment, the blender blade arm is configured to form a seal with the cup when the blender blade arm is coupled to the cup holder.

In one embodiment, the seal prevents liquid from flowing out of the cup.

In one embodiment, the cup arm is magnetically coupled to the cup holder.

In one embodiment, the apparatus further comprises a rinse cap, wherein the rinse cap is moved from a first position to a second position to couple to the blender blade arm when the cup holder is not coupled to the blender blade arm.

In one embodiment, the rinse cap is magnetically coupled to a rinse arm.

In one embodiment, in the first position, the rinse cap is configured horizontally and inverted and adjacent to the cup holder, and in the second position, the rinse cap is configured horizontally and inverted and above the cup holder to couple to the blender blade arm.

In one embodiment, the rinse cap is rotated around an axis and raised above the cup holder.

In one embodiment, the apparatus further comprises a cylinder coupled to the rinse cap, the cylinder comprising a groove, where the groove controls the movement of the rinse cap between the first position and the second position.

In one embodiment, the rinse cap is raised as the cup holder is lowered.

In one embodiment, the apparatus further comprises further comprising: a rinse arm coupled to the rinse cap; a rinse arm rail coupled to the rinse arm; a cup arm rail coupled to the cup arm; and a gear configured between the rinse are rail and the cup arm rail.

In one embodiment, the apparatus further comprises a pivot lever, wherein when the rinse arm rail is lowered to a minimum rinse arm rail height, the rinse arm rail disengages from the gear and rests on the pivot gear, and the pivot gear lifts the cup arm rail, and wherein when the cup arm rail is lowered to a minimum cup arm rail height, the cup arm rail disengages from the gear and rests on the pivot gear, and the pivot gear lifts the rinse arm rail.

In one embodiment, the blender blade arm is coupled to the blender blades using one or more clips coupled to the blender blade arm, wherein when the blender blade arm is in the third position the one or more clips are open, and wherein the one or more clips close as the blender blade arm moves away from the third position.

In one embodiment, the one or more clips comprise a plurality of clips configured on opposite sides of the blender blade arm.

In one embodiment, the one or more clips are coupled to one or more clip arms, and wherein one or more the clip arms open the one or more clips in response to engaging another element.

In one embodiment, the one or more clips are a plurality of clips, each clip comprising: a curved groove configured to receive a ball coupled to one of the clip arms; and a flat extended portion to engage an edge of cup holder.

In one embodiment, the apparatus further comprises a scale to measure the weight of the cup when the cup holder is in the first position.

In one embodiment, movement between the first position and second position and movement between the third position and fourth position is controlled by an automated food production software system.

In another embodiment, the present disclosure includes an apparatus comprising: cup holder means for holding a cup; cup arm means for coupled to the cup holder means for moving the cup holder between at least a first position and a second position; blender blades; blender blade arm means for rotating the blender blades around an axis between a third position and a fourth position; a blender motor to engage the blender blades, wherein when the cup holder means is in the second position, the blender blade arm means is moved to the third position and coupled to the cup holder means, and wherein when the blender blade arm means is rotated from the third position to the fourth position, the cup holder means is inverted and the blender blades engage the blender motor.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. An apparatus comprising:
a cup holder configured to receive a cup;
a cup arm coupled to the cup holder to move the cup holder between at least a first position and a second position;
blender blades;
a blender blade arm coupled to the blender blades, wherein the blender blade arm rotates around an axis between a third position and a fourth position;
a blender motor to engage the blender blades,
wherein when the cup holder is in the second position, the blender blade arm is moved to the third position and coupled to the cup holder, and
wherein when the blender blade arm is rotated from the third position to the fourth position, the cup holder is inverted and the blender blades engage the blender motor.

2. The apparatus of claim 1, wherein the blender blade arm is configured to form a seal with the cup when the blender blade arm is coupled to the cup holder.

3. The apparatus of claim 2, wherein the seal prevents liquid from flowing out of the cup.

4. The apparatus of claim 1, wherein the cup arm is magnetically coupled to the cup holder.

5. The apparatus of claim 1, further comprising a rinse cap, wherein the rinse cap is moved from a first position to a second position to couple to the blender blade arm when the cup holder is not coupled to the blender blade arm.

6. The apparatus of claim 5, wherein the rinse cap is magnetically coupled to a rinse arm.

7. The apparatus of claim 5, wherein in the first position the rinse cap is configured horizontally and inverted and adjacent to the cup holder, and in the second position the rinse cap is configured horizontally and inverted and above the cup holder to couple to the blender blade arm.

8. The apparatus of claim 7, wherein the rinse cap is rotated around an axis and raised above the cup holder.

9. The apparatus of claim 8, further comprising a cylinder coupled to the rinse cap, the cylinder comprising a groove, where the groove controls the movement of the rinse cap between the first position and the second position.

10. The apparatus of claim 8, wherein the rinse cap is raised as the cup holder is lowered.

11. The apparatus of claim 5, further comprising:
a rinse arm coupled to the rinse cap;
a rinse arm rail coupled to the rinse arm;
a cup arm rail coupled to the cup arm; and
a gear configured between the rinse are rail and the cup arm rail.

12. The apparatus of claim 11, further comprising a pivot lever,
wherein when the rinse arm rail is lowered to a minimum rinse arm rail height, the rinse arm rail disengages from the gear and rests on the pivot gear, and the pivot gear lifts the cup arm rail, and
wherein when the cup arm rail is lowered to a minimum cup arm rail height, the cup arm rail disengages from the gear and rests on the pivot gear, and the pivot gear lifts the rinse arm rail.

13. The apparatus of claim 1, wherein the blender blade arm is coupled to the blender blades using one or more clips coupled to the blender blade arm, wherein when the blender blade arm is in the third position the one or more clips are open, and wherein the one or more clips close as the blender blade arm moves away from the third position.

14. The apparatus of claim 13, wherein the one or more clips comprise a plurality of clips configured on opposite sides of the blender blade arm.

15. The apparatus of claim 13, wherein the one or more clips are coupled to one or more clip arms, and wherein one or more the clip arms open the one or more clips in response to engaging another element.

16. The apparatus of claim 15, wherein the one or more clips are a plurality of clips, each clip comprising:
a curved groove configured to receive a ball coupled to one of the clip arms; and
a flat extended portion to engage an edge of cup holder.

17. The apparatus of claim 1, further comprising a scale to measure the weight of the cup when the cup holder is in the first position.

18. The apparatus of claim 1, wherein movement between the first position and second position and movement between the third position and fourth position is controlled by an automated food production software system.

19. A method comprising:
moving a cup arm, coupled to a cup holder, between at least a first position and a second position;
rotating a blender blade arm, coupled to blender blades, around an axis between a third position and a fourth position,
wherein when the cup holder is in the second position, the blender blade arm is moved to the third position and coupled to the cup holder, and
wherein when the blender blade arm is rotated from the third position to the fourth position, the cup holder is inverted and the blender blades engage the blender motor.

20. An apparatus comprising:
cup holder means for holding a cup;
cup arm means for coupled to the cup holder means for moving the cup holder between at least a first position and a second position;
blender blades;
blender blade arm means for rotating the blender blades around an axis between a third position and a fourth position,
a blender motor to engage the blender blades,
wherein when the cup holder means is in the second position, the blender blade arm means is moved to the third position and coupled to the cup holder means, and
wherein when the blender blade arm means is rotated from the third position to the fourth position, the cup holder means is inverted and the blender blades engage the blender motor.
